(19) United States
(12) Patent Application Publication
(10) Pub. No.: US 2024/0111691 A1
(43) Pub. Date: Apr. 4, 2024

(54) TIME-AWARE NETWORK DATA TRANSFER

(71) Applicant: Intel Corporation, Santa Clara, CA (US)

(72) Inventors: Daniel Christian Biederman, Saratoga, CA (US); Kenneth Keels, Austin, TX (US); Renuka Vijay Sapkal, Milpitas, CA (US); Tony Hurson, Austin, TX (US)

(73) Assignee: Intel Corporation, Santa Clara, CA (US)

(21) Appl. No.: 18/532,079

(22) Filed: Dec. 7, 2023

(51) Int. Cl. G06F 12/14; G06F 15/173

(52) U.S. Cl. CPC G06F 12/145; G06F 12/1408; G06F 15/17331

(57) ABSTRACT

Techniques for time-aware remote data transfers. A time may be associated with a remote direct memory access (RDMA) operation in a translation protection table (TPT). The RDMA operation may be permitted or restricted based on the time in the TPT.

### BACKGROUND

Remote data transfer protocols permit devices to directly access memory of other devices via a network. However, conventional solutions may not fully utilize available bandwidth, may not fully utilize available memory, and may not support determinism.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of a computing architecture in accordance with one embodiment.

FIG. 2 illustrates an example remote data transfer operation in accordance with one embodiment.

FIG. 3 illustrates an example remote data transfer operation in accordance with one embodiment.

FIG. 4 illustrates an example remote data transfer operation in accordance with one embodiment.

FIG. 5 illustrates an example remote data transfer operation in accordance with one embodiment.

FIG. 6 illustrates an example of rate limiting data in accordance with one embodiment.

FIG. 7 illustrates an example data structure in accordance with one embodiment.

FIG. 8 illustrates a logic flow 800 in accordance with one embodiment.

FIG. 9 illustrates an aspect of a computing system in accordance with one embodiment.

### DETAILED DESCRIPTION

Embodiments disclosed herein utilize precise time for network data transfers, including but not limited to remote direct memory access (RDMA) transfers. Applications in data centers or other computing environments may need to run in real time. Embodiments disclosed herein provide a time-aware transport mechanism to move the data. For example, embodiments disclosed herein may use precise time to control an RDMA transfer (e.g., to define a window of time within which data can be transferred. In some examples, embodiments disclosed herein may use precise time and a rate of data consumption (e.g., by a processor or other computing component) to control an RDMA transfer. In some examples, embodiments disclosed herein use precise time to control an RDMA fence and/or invalidate data. In some embodiments, the RDMA transfers are based on RFC 5040: A Remote Direct Memory Access Protocol Specification or any other specifications defined by the RDMA consortium. In some embodiments, the RDMA transfers are based on the iWARP or InfiniBand technologies. Embodiments are not limited in these contexts.

In some embodiments, a translation protection table (TPT) may be extended to include time values. The time values may be used for any suitable purpose. For example, the time values may indicate when queue pairs allocated to an application can perform transmit and/or receive data operations. In some embodiments, keys may be associated with time values in the TPT, where the time values indicate when the keys are valid or invalid. Similarly, keys may have associated data rates (e.g., bytes per second, etc.). In some embodiments, memory operations have associated precise times in the TPT (e.g., loading data to memory, reading data from memory, invalidating data in memory, etc., according to precise times in the TPT). As another example, precise time entries in the TPT may be used to load data from a network interface controller (NIC) to a cache memory. Embodiments are not limited in these contexts.

As used herein, precise time and accurate time may be interchanged because the systems and techniques discussed herein provide both accurate time management and precise time management for network data transfers.

By leveraging precise time, embodiments disclosed herein may allow computing systems to utilize memory more efficiently than systems which do not use precise time. In addition and/or alternatively, by leveraging precise time, embodiments disclosed herein may provide better determinism than systems which do not use precise time. In addition and/or alternatively, by leveraging precise time, embodiments disclosed herein may allow computing systems to utilize bandwidth more efficiently than systems which do not use precise time. Embodiments are not limited in these contexts.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

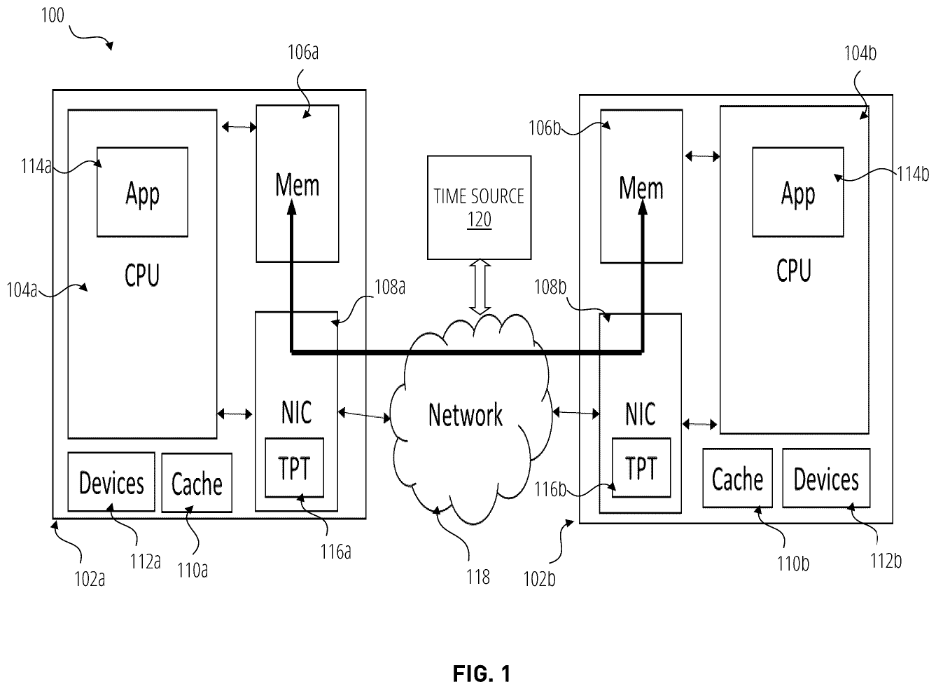

FIG. 1 is a schematic illustrating an example system 100 for time-aware network data transfer according to an embodiment. The system 100 comprises a computing system 102a and a computing system 102b communicably coupled via a network 118. As shown, the computing systems 102a, 102b include a respective processor 104a and processor 104b, a respective memory 106a and memory 106b, a respective network interface controller (NIC) 108a and NIC 108b, a respective processor cache 110a and cache 110b, respective devices 112a and devices 112b, each of which may be at least partially implemented in circuitry. The computing systems 102a, 102b are representative of any type of physical and/or virtualized computing system. For example, the computing systems 102a, 102b may be compute nodes, servers, infrastructure processing units (IPUs), data processing unit (DPUs), a networking appliance (e.g., a switch, a router, etc.), graphics processing unit (GPU), field programmable gate array (FPGA), general purpose GPU (GPGPU), accelerator device, artificial intelligence (AI) processor, a vector processor, a video processor, or any other type of computing system. In some embodiments, the NIC 108a and/or NIC 108b are examples of computing systems 102a, 102b. For example, the NIC 108a and/or NIC 108b may be an IPU, a chiplet that connects to a processor, and/or an IP core. Embodiments are not limited in these contexts. The devices 112a, 112b are representative of any type of device, such as graphics processing units (GPUs), accelerator devices, storage devices, FPGAs, GPUS, tensor flow processors, accelerators, peripheral devices, or any other type of computing device.

Although depicted as components of the computing systems 102a, 102b, the memories 106a, 106b may be located external to the computing systems 102a, 102b. For example, the memories 106a, 106b may be part of a memory pool. The memory pooling may be according to various architectures, such as the Compute Express Link® (CXL) architecture. Embodiments are not limited in these contexts.

As shown, an application 114a may execute on processor 104a and an application 114b may execute on processor 104b. The applications 114a, 114b are representative of any type of application. For example, the applications 114a, 114b may be one or more of AI applications, storage applications, networking applications, machine learning (ML) applications, video processing applications, gaming applications, applications that perform mathematical operations, Tensor Flow applications, database applications, computer vision applications, compression/decompression applications, encryption/decryption applications, or quantum computing applications. Although depicted as applications, the applications 114a, 114b may be implemented as any type of executable code, such as a process, a thread, or a microservice. Embodiments are not limited in these contexts.

As shown, the computing systems 102a, 102b may be coupled to a time source 120. The time source may be any type of time source, such as a clock, a network-based clock, an Institute of Electrical and Electronic Engineers (IEEE) 1588 time source, a precise time measurement (PTM) time source (e.g., over a link such as a peripheral component interconnect express (PCIe) or compute express link (CXL)), a time source that is based on pulses per second (PPS) (e.g., pulses generated by circuitry or other hardware components), or any combination thereof. In some embodiments, a time source 120 is a component of computing system 102a and computing system 102b. The time source 120 may generally provide precision time data such as timestamps to the computing systems 102a, 102b. The timestamps may be of any time granularity, such as the microsecond level, nanosecond level, and so on. In some embodiments, the synchronization to a time source 120 may use a combination of technologies. For example, the synchronization may be based on IEEE1588 over Ethernet and PTM over PCIe and PPS between chiplets.

As stated, the system 100 is configured to facilitate direct access of resources across the network 118 using RDMA. For example, using RDMA, the application 114a may access the memory 106b via the RDMA-enabled NICs 108a, 108b. Similarly, using RDMA, the application 114b may access the memory 106a via the RDMA-enabled NICs 108b, 108a. Although RDMA is used herein as an example, the disclosure is not limited to RDMA. The disclosure is equally applicable to other technologies for direct resource access. For example, any data transfer protocol that provides direct data placement functionality and kernel bypass functionality may be used. Direct data placement functionality may provide, to a source, the information necessary to place data on a target. Kernel bypass functionality may allow user space processes to do fast-path operations (posting work requests and retrieving work completions) directly with the hardware without involving the kernel (which may reduce overhead associated with system calls).

In some embodiments, RDMA runs on top of a transport protocol, such as RDMA over Converged Ethernet (RoCE), InfiniBand, iWARP, Ultra Ethernet, or another networking protocol. Embodiments are not limited in these contexts.

RDMA generally enables systems such as computing system 102a and computing system 102b to communicate across a network 118 using high-performance, low-latency, and zero-copy direct memory access (DMA) semantics. RDMA may reduce host processor utilization, reduce network-related host memory bandwidth, and reduce network latency compared to traditional networking stacks. The RDMA resources (queues, doorbells, etc.) allocated to applications 114a, 114b may be mapped directly into user or kernel application address space, enabling operating system bypass.

As shown, the NIC 108a includes a translation protection table (TPT) 116a and NIC 108b includes a TPT 116b. Generally, a TPT may be similar to a memory management unit (MMU) of a processor. Some entries in a TPT may include translations from virtual memory pages (or addresses) to physical memory pages (or addresses). Some entries in a TPT may define a memory region or a memory window in memory such as memory 106a or memory 106b. A memory region may be a virtually or logically contiguous area of application address space (e.g., a range of memory addresses) which may be registered with an operating system (OS). A memory region allows an RDMA NIC such as NICs 108a, 108b to perform DMA access for local and remote requests. The memory region also enables user space applications such as applications 114a, 114b to deal with buffers in virtual address space. A memory window may be used to assign a Steering Tag (STag) to a portion (or window) of a memory region. Some entries in the TPT may include indications of RDMA keys. Embodiments are not limited in these contexts.

The entries in TPT 116a, TPT 116b may include time information. The time information may include timestamps (or time values) generated by the time source 120. The time information may be a single timestamp or a range of two or more timestamps. Generally, the time information allows the NICs 108a, 108b to enable precision time for RDMA operations. Example RDMA operations that may use the time information in the TPT 116a, 116b include RDMA write operations, RDMA read operations, RDMA send operations, RDMA memory operations (MEMOPS) such as fast memory registrations, invalidations to invalidate a memory region or a memory window, binding operations to create a memory window bound to an underlying memory region, and the like. In some embodiments, the time information in the TPTs 116a, 116b may include timing information for time-based access to memory regions that have different CPU, cache, socket, and/or memory channel affinities. Further still, the applications 114a, 114b may include timing information to provide control over how individual messages (e.g., sends, writes, reads etc.) go out onto the wire, via time information inserted in message work descriptors (e.g., work queue entries, or WQEs). In such embodiments, applications 114a, 114b post these the descriptors to the NICs 108a, 108b, requesting data transfer. The NIC 108b or NIC 108b may include the timing information in a message work descriptor in one or more entries of the TPTs 116a, 116b.

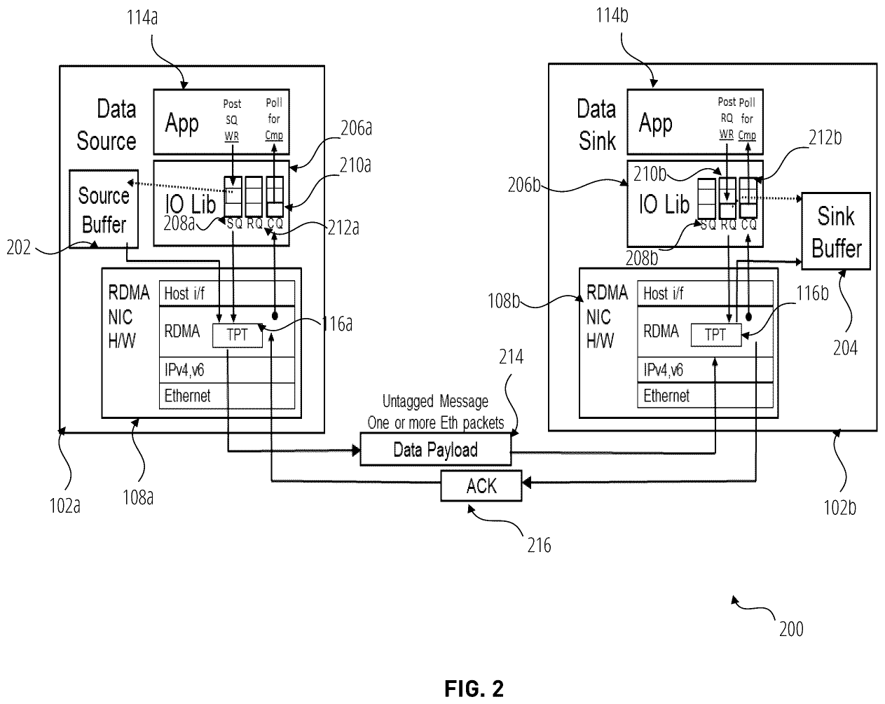

For example, the TPTs 116a, 116b may define times when different hardware and/or software entities are allowed to transmit or receive data. For example, the TPTs 116a, 116b may define times when applications 114a, 114b may transmit or receive data. Similarly, the TPTs 116a, 116b may define times when queue pairs (see, e.g., FIG. 2) allocated to the applications 114a, 114b may transmit or receive data. Doing so may reduce the number of entries in the TPTs 116a, 116b at a given time. Furthermore, the TPTs 116a, 116b may be updated at precise times with the queue pairs that are allowed to transmit or receive data at that time. The TPTs 116a, 116b may further define times when the RDMA keys are valid (or invalid). In some embodiments, entries in the TPTs 116a, 116b may include data rates (e.g., bits per time-period).

In some embodiments, access to the TPTs 116a, 116b may be limited to predetermined times. For example, in some embodiments, entries may be added to the TPTs 116a, 116b at predetermined times. Similarly, in some embodiments, entries in the TPTs 116a, 116b may be accessed at predetermined times. In some embodiments, the entries in the TPTs 116a, 116b may be used to provide Quality of Service (QoS). Embodiments are not limited in these contexts.

Further still, the TPTs 116a, 116b may associate times with RDMA MEMOPS. For example, using times in the TPTs 116a, 116b, the fast memory registrations may occur at precise times. Similarly, using times in the TPTs 116a, 116b, a local invalidate may occur at a precise time freeing up memory for the next application, or the next data set for the same application. For example, consider an AI cluster where images are ping-ponged into two memory areas. Using times in the TPTs 116a, 116b, the first memory area could be loaded at a precise time and processing will stop at a precise time, while the second area is loading. The processing of the first area has a known precise time as specified by the TPTs 116a, 116b. This time can be used to invalidate the area, as the AI moves to the other buffer. Since the area has been invalidated, new RDMA transfers could fill that area, which may save time and memory area.

RDMA may support fencing operations, e.g., to block an RDMA operation from executing until one or more other RDMA operations have completed. In some embodiments, times in the TPTs 116a, 116b may be used as a fence. Returning to the ping-pong buffer example, there may be one buffer transfer ever 16.7 microseconds. The RDMA command may establish a fence (e.g., using the TPTs 116a, 116b) that the second buffer transfer should not start until after 16.7 microseconds (or 16.7-x microseconds after the first time, where x may be the time to transfer the first bytes of data over the network). Similarly, when the first buffer is “done” an invalidate command may free up the memory, and the fence could transfer knowing that the new data would arrive after the time-based invalidate.

In some such embodiments, the images may be received from multiple sources (e.g., cameras, storage appliances, etc.). In such embodiments, there may be multiple ping-pong operations in parallel, which may be staggered at different precise times. The parallel operations may be operated using precise time in such a way that they do not overwhelm/overflow/collide with other “jobs or threads” accessing a shared resource. Embodiments are not limited in these contexts.

FIG. 2 is a schematic 200 illustrating an example RDMA send operation. In the example depicted in FIG. 2, the application 114a may send data to an untagged sink buffer 204 in memory 106b of computing system 102b for consumption by application 114b.

Regardless of the type of RDMA operation being performed, an application such as application 114a or application 114b communicates with an RDMA enabled NIC such as NIC 108a or NIC 108b using one or more queue pairs (QPs). A given queue pair may include a send queue (SQ), a receive queue (RQ), and a completion queue (CQ).

A send queue (also referred to as a “submission queue”) is used for the application to post work requests (WRs) to transmit data (or a read request) to the remote system. A work request may have one or more opcodes which may include: send, send with solicited event, RDMA Write, RDMA Read, etc. The receive queue is used for the application to post work requests with buffers for placing untagged messages from the remote system. Elements in the completion queue indicate, to the application, that a request has been completed. The application may poll the completion queue to identify any completed operations. The CQ may be associated with one or more send queues and/or one or more receive queues.

Therefore, as shown, application 114a is allocated, in an input/output (IO) library 206a, one or more send queues 208a, one or more receive queues 210a, and one or more completion queues 212a. Similarly, as shown, application 114b is allocated in IO library 206b, one or more send queues 208b, one or more receive queues 210b, and one or more completion queues 212b. Furthermore, the applications 114a, 114b may be allocated a respective set of RDMA keys (not pictured) for each queue pair. The RDMA keys may include, for each queue pair, a P_Key, Q_Key, a local key (also referred to as “L_Key”) (STag), a remote key (also referred to as “R_Key”) (STag), or an S_Key. A P_Key is carried in every transport packet because QPs are required to be configured for the same partition to communicate. The Q_Key enforces access rights for reliable and unreliable datagram service. During communication establishment for datagram service, nodes exchange Q_Keys for each QP and a node uses the value it was passed for a remote QP in all packets it sends to that remote QP. When a consumer (e.g., an application) registers a region of memory, the consumer receives an L_Key. The consumer uses the L_Key in work requests to describe local memory to the QP. When a consumer (e.g., an application) registers a region of memory, the consumer receives an R_Key. The consumer passes the R_Key to a remote consumer for use in RDMA operations.

Therefore, to send data to memory 106b, application 114a may post an indication of the send operation to the send queue 208a. The data for the send operation may be provided to a source buffer 202 allocated to the application 114a. The source buffer 202 may be referenced in the entry in the send queue 208a as a Scatter Gather List (SGL). Each element in the SGL may be a three tuple of [Stag/L-Key, tagged offset (TO), and Length]. Similarly, the application 114b may post an indication of the send operation to the receive queue 210b. The entry in the receive queue 210b may be referenced as a SGL, where the SGL element includes the three tuple of [STag/L-Key, TO, and Length].

As stated, the TPT 116a and TPT 116b may store time information. In some embodiments, the time information may be associated with a QP. In some embodiments, the time information is associated with a SQ, a RQ, and/or a CQ. For example, NIC 108a may allocate, in the TPT 116a, a timestamp indicating a time (or a range of time) when the send queue 208a can transmit data via the NIC 108a. Similarly, the NIC 108b may allocate, in the TPT 116b, a timestamp indicating a time (or range of time) when the receive queue 210b can receive data.

Thereafter, the NIC 108a may process the send operation in the send queue 208a based on a current time. For example, if a timestamp associated with a current time is before a timestamp in the TPT 116a, the NIC 108a may refrain from processing the send operation until the current time is greater than the timestamp. Once the current time is greater than the timestamp in the TPT 116a, the NIC 108a may process the send operation.

As another example, the NIC 108a may allocate, in the TPT 116a, two or more timestamps forming one more windows of time that the send queue 208a can transmit data via the NIC 108a. If the current time is within one of the permitted time windows, the NIC 108a may permit the data transfer. Otherwise, if the current time is not within one of the permitted time windows, the NIC 108a may hold or otherwise restrict the data transfer until the current time is within one of the permitted time windows.

Once the send operation is permitted, the NIC 108a may read the data from the source buffer 202 and transmit the data 214 for the send operation to the computing system 102b via one or more packets. The NIC 108b may receive the data 214 and determine if the receive queue 210b is permitted to receive the data 214. For example, the NIC 108b may reference the TPT 116b and determine the time associated with the entry for the receive queue 210b. If the time associated with the entry for the receive queue 210b is a single timestamp, the NIC 108b may determine whether a current time is subsequent to the timestamp. If the time is subsequent to the timestamp, the NIC 108b may permit further processing of the data 214. Similarly, if the time in the TPT 116b for the receive queue 210b is two or more timestamps forming one more windows of time that the receive queue 210b can receive data via the NIC 108b, the NIC 108b may determine if the current time is within one of the permitted time windows. If the current time is within one of the permitted time windows, the NIC 108b may permit the incoming data transfer. Otherwise, if the current time is not within one of the permitted time windows, the NIC 108a may hold or otherwise restrict the data transfer until the current time is within one of the permitted time windows.

Once permitted, the NIC 108b may determine a location in the sink buffer 204 based on the entry for the operation in the receive queue 210b and store the data 214 at the determined location. The NIC 108b may then generate an entry in the completion queue 212b for the transfer, which may be read by the application 114b. The application 114b may then access the data 214 in the sink buffer 204 (or another memory location). In some embodiments, however, the data is stored in the sink buffer 204 prior to the time the receive queue 210b is permitted to receive the data 214. In such embodiments, the data 214 is stored in the sink buffer 204 and the time in the TPT 116b is used to determine when to generate the entry in the completion queue 212b. The sink buffer 204 may be any type of buffer. For example, the sink buffer 204 may be a low latency memory such as a cache or first-in first-out (FIFO) memory structure. In some embodiments, the sink buffer 204 may be a portion of the cache that is controlled by the NIC 108a or NIC 108b, or similar memory mechanism. In some embodiments, the sink buffer 204 is a locked area of the cache, which may be reserved by a QoS mechanism. Embodiments are not limited in these contexts.

The NIC 108b may then generate an acknowledgment 216 that is sent to the NIC 108a. The NIC 108a may receive the acknowledgment 216 and generate an entry in the completion queue 212a indicating the send operation was successfully completed.

As stated, the entries in the TPTs 116a, 116b may include data rate information. In some embodiments, the data rate is used to manage application access to RDMA operations without considering timestamps. In some embodiments, the data rate is used in conjunction with the timestamps to manage application access to RDMA operations. For example, in the send operation, the send request may include a precise start time, a data transfer rate, and/or a final transfer time, where the final transfer time is a time by which all data should be transferred.

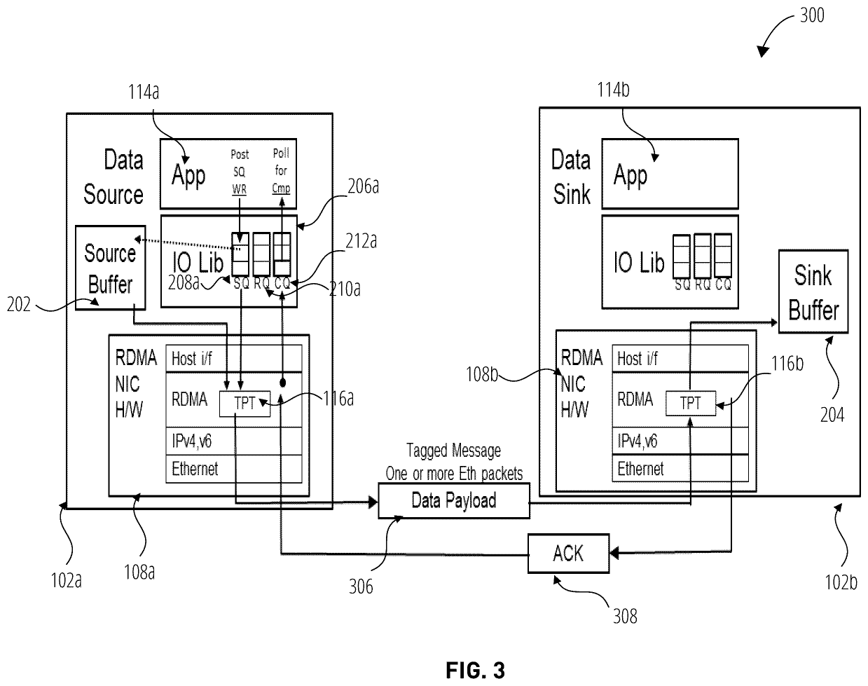

FIG. 3 is a schematic 300 illustrating an example RDMA write operation. In the example depicted in FIG. 3, the application 114a may write data 302 to a tagged sink buffer 204 in memory 106b of computing system 102b.

To write the data 302 to the sink buffer 204, application 114a may post an indication of the write operation to the send queue 208a. The data 302 for the write operation may be provided to a source buffer 202 allocated to the application 114a. The source buffer 202 may be referenced in the send queue 208a as a Scatter Gather List (SGL). Each element in the SGL for the source buffer in the send queue 208a may be a three tuple of [Stag/L-Key, TO, and Length].

As stated, to write the data 302 to the sink buffer 204, the NIC 108a may determine whether the send queue 208a is permitted to perform the write operation based on the TPT 116a. For example, the NIC 108a may determine whether a timestamp of a current time is greater than a timestamp associated with the send queue 208a in the TPT 116a. If the current timestamp is not greater than the timestamp associated with the send queue 208a, the NIC 108a may refrain from writing the data 302 until the timestamp is greater than the timestamp associated with the send queue 208a. As another example, the NIC 108a may determine whether the timestamp of the current time is within one or more windows of time associated with the send queue 208a in the TPT 116a. If the current timestamp is not within the one or more windows of time associated with the send queue 208a, the NIC 108a may refrain from writing the data 302 until the timestamp is within the one or more windows of time associated with the send queue 208a.

Once the NIC 108a determines the send queue 208a is permitted to write the data 302, the NIC 108a transmits one or more tagged packets including the data 302 to the NIC 108b. The NIC 108b then writes the data 302 to the sink buffer 204 upon receipt. The NIC 108b then generates and sends an acknowledgment 304 to the NIC 108a. When the NIC 108a receives the acknowledgment 304, the NIC 108a generates an entry in the completion queue 212a indicating the write operation was successfully completed.

In some embodiments, the NICs 108a, 108b may use the TPTs 116a, 116b to pace the fetch of the data payload. In some embodiments, the NICs 108a, 108b may include, in the fetch, the desired data, a data rate, a destination time, a QoS metric, and/or a SLA metric. In some embodiments, a default read/write rate may be implemented. The acknowledgment 304 may return updates regarding pacing changes using Enhance Transmission Selection (ETS). ETS may be used as a weighted round robin algorithm, a weighted queue algorithm, and/or an arbiter. Generally, in ETS, each traffic class may have a minimum QoS. In some embodiments, however, all available bandwidth may be used for an RDMA operation.

As stated, the entries in the TPTs 116a, 116b may include data rate information. In some embodiments, the data rate is used to manage application access to RDMA operations without considering timestamps. In some embodiments, the data rate is used in conjunction with the timestamps to manage application access to RDMA operations. For example, in the write operation, the write request may include a precise start time, a data transfer rate, and/or a final transfer time, where the final transfer time is a time by which all data should be transferred.

In some embodiments, storage for RDMA reads and/or RDMA writes may be disaggregated. In such embodiments, a rate may be defined in the TPTs 116a, 116b at the time of memory registration to allocate a target bounce buffer. Thereafter, the data may be read and/or written at that defined rate. In some embodiments, the rate is a consumption rate, a time-division multiplexing (TDM) slot, or any other window of communication. In some embodiments, a write acknowledgment may include details about when certain data is requested (e.g., at a data rate, at a time, etc.). In some embodiments, the rate of consumption may be dynamic. In some embodiments, the rate of consumption may be based on hints from the memory, such as PCIe or CXL hints.

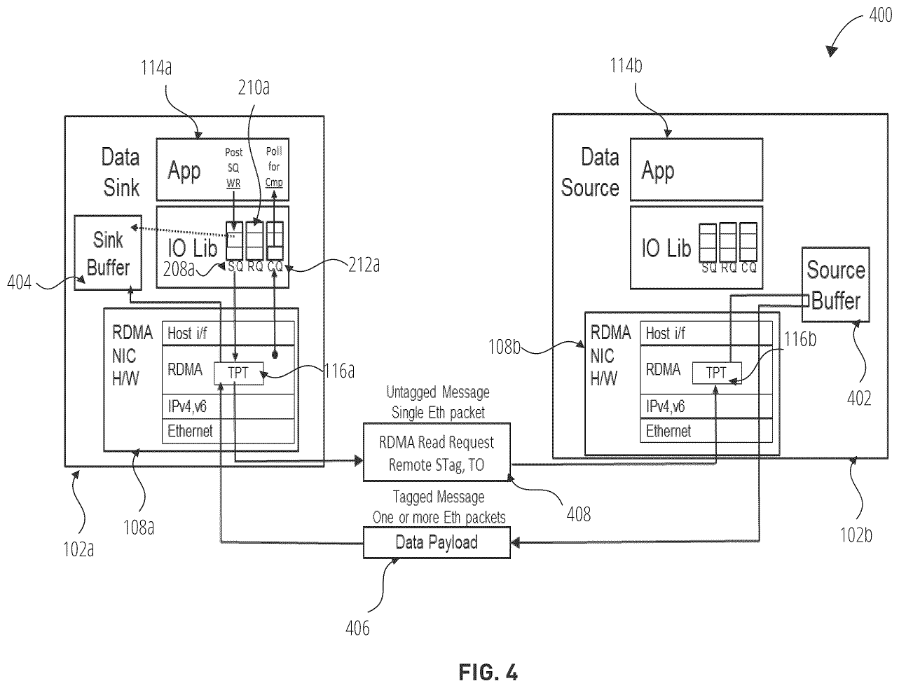

FIG. 4 is a schematic 400 illustrating an example RDMA read operation. In the example depicted in FIG. 4, the application 114a may read data 406 from a source buffer 402 in memory 106b of computing system 102b to a sink buffer 404 in memory 106a of computing system 102a.

To read the data 406, application 114a may post an indication of the read operation to the receive queue 210a. The indication of the read operation in the receive queue 210a may include an indication of the source buffer 402, which may be referenced in as a Scatter Gather List (SGL). The SGL for the indication of the read operation in the receive queue 210a may be a three tuple of [STag/R-Key, TO]. Furthermore, the indication of the read operation in the receive queue 210a ma include an indication of the sink buffer 404, which may be referenced as an element of a SGL, where the SGL includes a three tuple of [STag/L-Key, TO, and Length].

As stated, to read the data 406, the NIC 108a may determine whether the receive queue 210a is permitted to perform the read operation based on the TPT 116a. For example, the NIC 108a may determine whether a timestamp of a current time is greater than a timestamp associated with the receive queue 210a in the TPT 116a. If the current timestamp is not greater than the timestamp associated with the receive queue 210a, the NIC 108a may refrain from reading the data 302 until the timestamp is greater than the timestamp associated with the send queue 208a. As another example, the NIC 108a may determine whether the timestamp of the current time is within one or more windows of time associated with the receive queue 210a in the TPT 116a. If the current timestamp is not within the one or more windows of time associated with the receive queue 210a, the NIC 108a may refrain from reading the data 406 until the timestamp is within the one or more windows of time associated with the receive queue 210a.

Once the NIC 108a determines the receive queue 210a is permitted to receive the data 406, the NIC 108a transmits a request 408 to the NIC 108b. The request 408 may be an untagged message in a single Ethernet packet. The request 408 may include an indication that the operation is an RDMA read operation, a remote STag, and a TO.

The NIC 108b then reads the data 406 from the source buffer 402 responsive to receiving the request 408. The NIC 108b then generates and sends one or more packets including the data 406 to the NIC 108a. Responsive to receiving the packets of data 406, the NIC 108a writes the data 406 to the sink buffer 404. The NIC 108a may also generate an entry in the completion queue 212a indicating the read operation was successfully completed.

In some embodiments, the entries in the TPTs 116a, 116b may be used to pace the fetching of elements in the send queues 208a, 208b by the NICs 108a, 108b. In some embodiments, the NICs 108a, 108b may submit reads to indicate how the remote host should pace the read data (e.g., based on one or more of a data rate, a destination time, a QOS metric, and/or an service level agreement (SLA) metric). In some embodiments, the NICs 108a, 108b may break the read operation into smaller suboperations to refrain from overflowing memory.

As stated, the entries in the TPTs 116a, 116b may include data rate information. In some embodiments, the data rate is used to manage application access to RDMA operations without considering timestamps. In some embodiments, the data rate is used in conjunction with the timestamps to manage application access to RDMA operations. For example, in the read operation, the read request may include a precise start time, a data transfer rate, and/or a final transfer time, where the final transfer time is a time by which all data should be transferred.

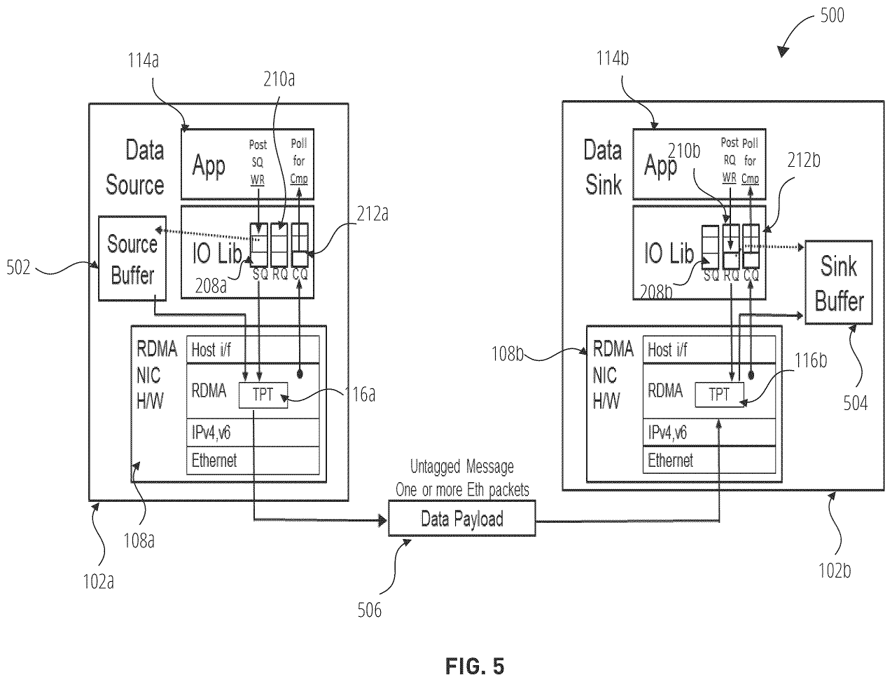

FIG. 5 is a schematic 500 illustrating an example unreliable datagram (UD) send operation. In the example depicted in FIG. 5, the application 114a may send data 506 to a sink buffer 504 in memory 106b of computing system 102b for consumption by application 114b.

To send data to memory 106b, application 114a may post an indication of the send operation to the send queue 208a. The data for the send operation may be provided to a source buffer 502 allocated to the application 114a. The source buffer 502 may be referenced in the entry in the send queue 208a as a Scatter Gather List (SGL). Each element in the SGL may be a three tuple of [Stag/L-Key, TO, and Length]. Similarly, the application 114b may post an indication of the send operation to the receive queue 210b, which may include an entry of the sink buffer 504. The entry in the receive queue 210b may be referenced as a SGL, where the SGL element includes the three tuple of [STag/L-Key, TO, and Length].

As stated, to send the data 506 to the sink buffer 504, the NIC 108a may determine whether the send queue 208a is permitted to perform the send operation based on the TPT 116a. For example, the NIC 108a may determine whether a timestamp of a current time is greater than a timestamp associated with the send queue 208a in the TPT 116a. If the current timestamp is not greater than the timestamp associated with the send queue 208a, the NIC 108a may refrain from sending the data until the timestamp is greater than the timestamp associated with the send queue 208a. As another example, the NIC 108a may determine whether the timestamp of the current time is within one or more windows of time associated with the send queue 208a in the TPT 116a. If the current timestamp is not within the one or more windows of time associated with the send queue 208a, the NIC 108a may refrain from sending the data until the timestamp is within the one or more windows of time associated with the send queue 208a.

Once the send operation is permitted, the NIC 108a may read the data from the source buffer 502 and transmit the data 506 for the send operation to the computing system 102b via one or more packets. Because the NIC 108b will not send an acknowledgment for the UD send operation, the NIC 108a generates an entry in the completion queue 212a for the send operation after sending the data 506.

The NIC 108b may receive the data 506 and determine if the receive queue 210b is permitted to receive the data 214. For example, the NIC 108b may reference the TPT 116b and determine the time associated with the entry for the receive queue 210b. If the time associated with the entry for the receive queue 210b is a single timestamp, the NIC 108b may determine whether a current time is subsequent to the timestamp. If the time is subsequent to the timestamp, the NIC 108b may permit further processing of the data 214. Similarly, if the time in the TPT 116b for the receive queue 210b is two or more timestamps forming one more windows of time that the receive queue 210b can receive data via the NIC 108b, the NIC 108b may determine if the current time is within one of the permitted time windows. If the current time is within one of the permitted time windows, the NIC 108b may permit the incoming data transfer. Otherwise, if the current time is not within one of the permitted time windows, the NIC 108a may hold or otherwise restrict the data transfer until the current time is within one of the permitted time windows.

Once permitted, the NIC 108b may determine a location in the sink buffer 504 based on the entry for the operation in the receive queue 210b and store the data 506 at the determined location. The NIC 108b may then generate an entry in the completion queue 212b for the transfer, which may be read by the application 114b. The application 114b may then access the data 506 in the sink buffer 204 (or another memory location). In some embodiments, however, the data 506 is stored in the sink buffer 204 prior to the time the receive queue 210b is permitted to receive the data 506. In such embodiments, the data 506 is stored in the sink buffer 204 and the time in the TPT 116b is used to determine when to generate the entry in the completion queue 212b.

In some embodiments, the information in the TPTs 116a, 116b may be used in one-way transfer time determination. Conventional RDMA transfers may use two-way latency measurements, that are divided by two to determine one-way latency. However, if there is congestion in one direction and not the other, the divide by two method does not show the accurate congestion of one way. Hence if an acknowledgment (ACK) or other RDMA response includes the one-way latency, the RDMA protocol could respond appropriately. In other words, one may want to rate control in one direction, but if all the variation and delay is in other path, the rate controlling occurs the wrong direction.

Furthermore, the NICs 108a, 108b may use the precise time in the TPTs 116a, TPT 116b for an arriving data stream as well as the precise time at the device or host to place the data into the associated memory 106a, 106b just in time. For example, the RDMA block of the NICs 108a, 108b may hold and coalesce incoming RDMA data such that it delivers the data to the CPU and/or memory precisely in time to use the data.

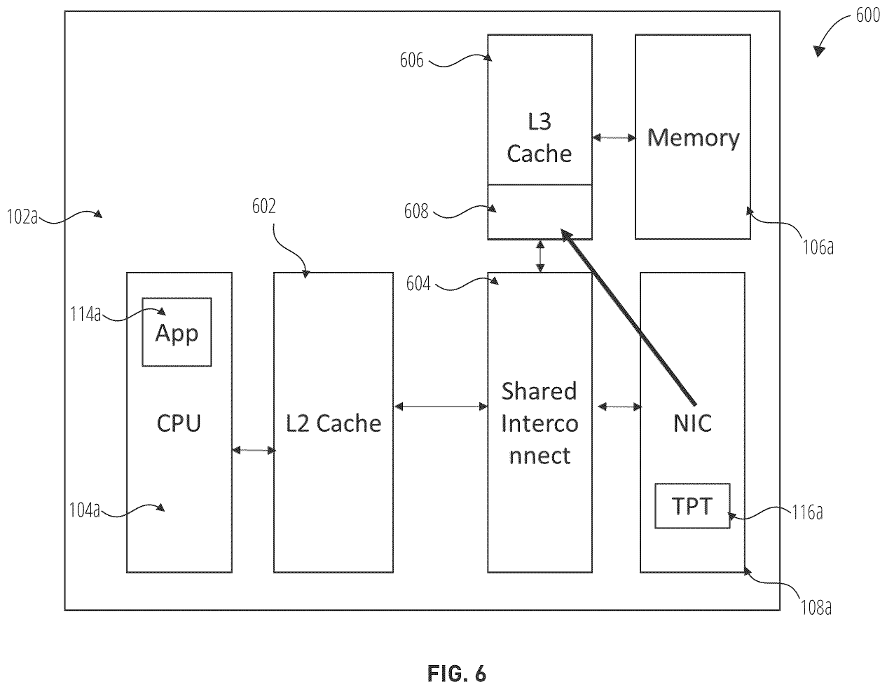

FIG. 6 is a schematic 600 illustrating an example of using precise time to fill data in a cache, according to one embodiment. As shown, the schematic 600 includes the computing system 102a, which further includes an L2 cache 602, a shared interconnect 604, and an L3 cache 606. A NIC accessible portion 608 of the L3 cache 606 may be accessible to the NIC 108a for specified functions. For example, RDMA queue entries and pointers (send queue entries, completion queue entries, head/tail pointers, etc.) may be stored in the NIC accessible portion 608 for quick examination by the processor 104a by locking the locations of these variables/parameters/entries into the L3 cache 606. Similarly, the NIC 108a could reserve a portion of the NIC accessible portion 608 of the L3 Cache. Doing so allows the NIC 108a to directly place the data into the L3 cache in a timely manner, instead of storing the data to memory 106a prior to the data being brought up to the L3 cache 606. Doing so may save memory, power, latency and bandwidth (PCIe, Memory, Cache).

For example, the NIC 108a may receive data (not pictured). The NIC 108a may reference the TPT 116a to determine a rate of consumption of data by the processor 104a from the NIC accessible portion 608 of the L3 cache 606. The NIC 108a may determine, based on the rate of consumption and a current time, precisely when to write the data to the NIC accessible portion 608 of the L3 cache 606. For example, if the processor 104a is consuming data from the NIC accessible portion 608 at a rate of 1 gigabit per second, the NIC 108a may cause the NIC accessible portion 608 to be filled with 1 gigabit of data each second at precise timing intervals. In some embodiments, the NIC 108a may hold and coalesce incoming RDMA data such that the NIC 108a delivers the data to the L3 cache 606 precisely in time to be used by the processor 104a.

Although NIC accessible portion 608 is used as an example mechanism to reserve the L3 cache 606, embodiments are not limited in these contexts. For example, other types of caches may be accessible to the NICs 108a, 108b, such as an L1 cache or the L2 cache 602, a dedicated cache, a memory structure (e.g., a FIFO, a scratchpad), and/or a memory structure inside a cache (e.g., a FIFO, scratchpad). The NIC accessible portion 608 may be accessed by a NIC 108a, 108b using any suitable technology. Examples of technologies to access the NIC accessible portion 608 include the Intel® Data Direct I/O Technology (Intel® DDIO) and Cache Stashing by ARM®. Embodiments are not limited in these contexts.

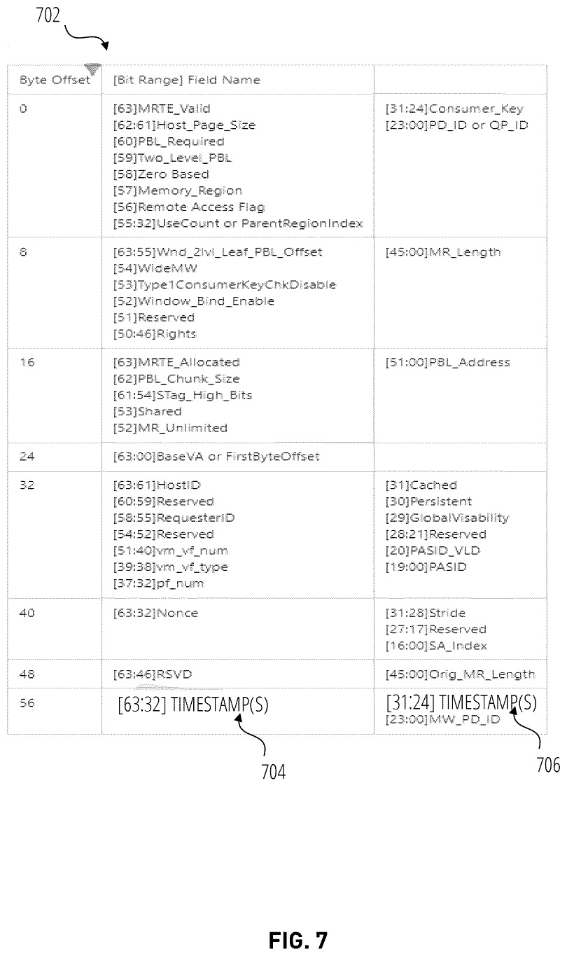

FIG. 7 illustrates a data structure 702. The data structure 702 may be representative of some or all of the entries in the TPT 116a or TPT 116b. As shown, the data structure 702 includes a timestamp field 704 for one or more timestamps. Similarly, one or more timestamps 706 may be stored in the timestamp field 704 of an entry in the TPT 116a or TPT 116b. In some embodiments, the timestamps 706 are stored in one or reserved bits of the data structure 702. Embodiments are not limited in these contexts.

In some embodiments, the timestamp 706 includes 64 bits. However, in some embodiments, the timestamp 706 may include fewer or more than 64 bits. The number of bits may be based on nanoseconds, tens of picoseconds, or fractions of microseconds. The number of bits may be based of some known period of time and/or epoch. Embodiments are not limited in this context.

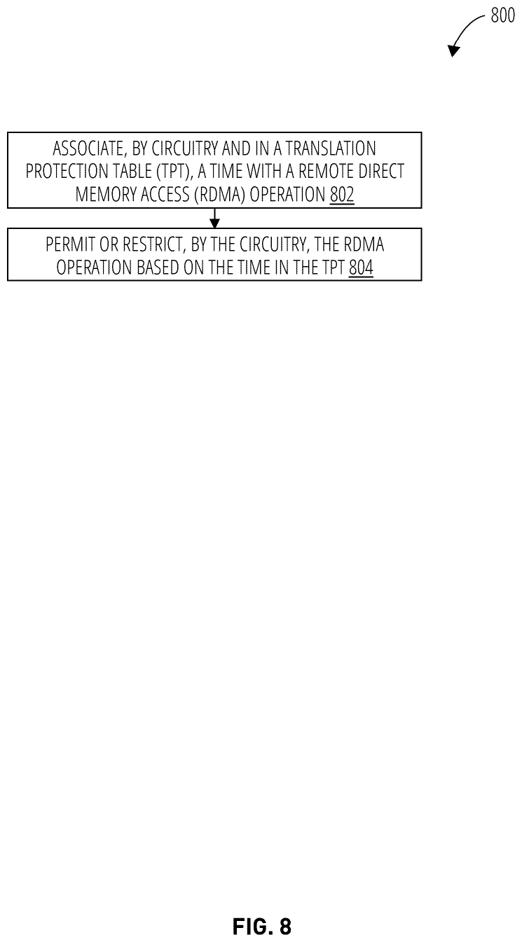

FIG. 8 illustrates an embodiment of a logic flow 800. The logic flow 800 may be representative of some or all of the operations executed by one or more embodiments described herein. For example, the logic flow 800 may include some or all of the operations to provide time aware network data transfers. Embodiments are not limited in this context.

In block 802, logic flow 800 associates, by circuitry and in a translation protection table (TPT), a time with a remote direct memory access (RDMA) operation. For example, NIC 108a may associate a timestamp with an application 114a in a TPT 116a. In block 804, logic flow 800 permits or restricts, by the circuitry, the RDMA operation based on the time in the TPT. For example, if the NIC 108a determines the RDMA is permitted based on the time in the TPT 116a and a current time, the NIC 108a processes the RDMA operation. Otherwise, the NIC 108a may restrict or otherwise refrain from processing the RDMA operation until permitted.

More generally, embodiments disclosed herein provide an RDMA TPT such as TPTs 116a, 116b, that use precise time as an attribute. An RDMA Translation Protection Table that uses precise time as an attribute. The precise time may allow certain queue pairs to have times when they are allowed to transmit data. The precise time may allow certain queue pairs to have times when they are allowed to receive data. The use of precise time reduces the number of entries in the TPTs 116a, 116b at a given time. The TPTs 116a, 116b may be updated at precise times with the queue pairs that should occur during that time. In some embodiments, RDMA cache memories such as the L3 cache 606 are loaded based on known times as specified in the TPTs 116a, 116b. In some embodiments, RDMA cache memories such as the L3 cache 606 are evicted based on known times specified in the TPTs 116a, 116b. Doing so may provide a performance increase seen due to the precise time the memory is updated. In some embodiments, coalescing occurs based on the precise time in the TPTs 116a, 116b. In some embodiments, the coalescing occurs in the NIC 108a, NIC 108b, the computing system 102a, the computing system 102b, or any component thereof. In some embodiments, an invalidate occurs based on the precise time in the TPTs 116a, 116b. In some embodiments, the TPTs 116a, 116b may only be accessed when there are enough credits. In some embodiments, the credits are assigned (e.g., to an application 114a, application 114b, other hardware element, or other software elements) at a precise time. In some embodiments, the credits are updated at a precise time. In some embodiments, the credits accumulate based on a rate based on precise time.

In some embodiments, RDMA keys are associated with a precise time in the TPTs 116a, 116b. The key may be the P_Key. The key may be the Q_Key. The key may be the L_Key. The key may be the R_Key. The key may be the S_Key. In some embodiments, the key association can may occur during a precise time as specified in the TPTs 116a, 116b. As such, the key association may not occur during other precise times. In some embodiments, the precise time may indicate when the key is valid. In some embodiments, the time is a window of time. In some embodiments, the precise time indicates when the key is not valid. In some embodiments, the time is a window of time. In some embodiments, the precise time indicates a data rate. In some embodiments, the rates indicates a number of bits or bytes per time-period. In some embodiments, the rate is in bytes per nanosecond. In some embodiments, the rate is in kilobits (KBs) per microsecond. In some embodiments, the rate is in megabits (MBs) per microsecond.

In some embodiments, the processing of the RDMA key may occur in software. In some embodiments, the processing of the RDMA key may occur in hardware. In some embodiments, the hardware is an IPU. In some embodiments, the hardware is a NIC. In some embodiments, the hardware is a processor. In some embodiments, the hardware is a GPU. In some embodiments, the precise time is used as part of an RDMA QoS Scheme. In some embodiments, the QoS Scheme provides an SLA and/or a service level objective (SLO).

In some embodiments, the QoS Scheme uses time slots. In some embodiments, the precise times are arranged to provide processing classes or traffic classes between RDMA consumers. In some embodiments, the QoS Scheme allows for appropriate multihost operation. In some embodiments, the QoS Scheme provides processes of any size the time required by the QoS scheme for RDMA operations. In some embodiments, the QoS Scheme provides processes of any size the bandwidth required by the QoS scheme for RDMA operations. In some embodiments, the QoS Scheme provides processes of any size the latency required by the QoS scheme for the RDMA operations.

In some embodiments, one or more RDMA parameters are assigned at a time. In some embodiments, the RDMA parameters are part of the connection profile. In some embodiments, a connection profile is determined at a precise time or precise time window. In some embodiments, a connection profile cannot change after a precise time. In some embodiments, the RDMA parameters are part of resource allocations to a host system. In some embodiments, the resource is available during a precise time or precise time window. In some embodiments, the resource allocation is credits. In some embodiments, the resource allocation is credits per time. In some embodiments, the resource allocation is a memory allocation. In some embodiments, the resource allocation is a bandwidth allocation. In some embodiments, the resource allocation is based on queue depth. In some embodiments, the queue depth is the send queue depth. In some embodiments, the queue depth is the completion queue depth. In some embodiments, the queue depth is a receiving queue depth. In some embodiments, the queue depth is related to the depth of a queue pair.

In some embodiments, a Remote Data Transfer protocol allows for isolation based on precise time. The time may be specified in the TPTs 116a, 116b. In some embodiments, the precise time indicates transfer windows to a specific host. In some embodiments, this window of time is used for isolation. In some embodiments, the isolation is between two or more hosts (host isolation). In some embodiments, the isolation is between two or more network ports. In some embodiments, the isolation is between two or more memory regions. In some embodiments, the memory region is in a cache. In some embodiments, the memory region is in host memory. In some embodiments, the memory region is across a CXL interface. In some embodiments, the memory region is across a PCIe interface. In some embodiments, the memory region is across an Ethernet interface. In some embodiments, the isolation is between two or more virtual machines (virtual machine isolation). In some embodiments, the isolation is between two or more devices. In some embodiments, the devices includes at least one processor. In some embodiments, the devices includes at least one GPU. In some embodiments, the devices includes at least one accelerator. In some embodiments, the accelerator is an AI accelerator. In some embodiments, the accelerator is a Math accelerator.

In some embodiments, the precise time (e.g., in the TPTs 116a, 116b) indicates one or more “do not transfer” windows to a specific host. In some embodiments, this window of time is used for isolation. In some embodiments, the isolation is between two or more hosts. In some embodiments, the isolation is between two or more ports. In some embodiments, the isolation is between two or more virtual machines. In some embodiments, the isolation is between two or more devices. In some embodiments, the devices includes at least one processor. In some embodiments, the devices includes at least one GPU. In some embodiments, the devices includes at least one accelerator. In some embodiments, the accelerator is an AI accelerator. In some embodiments, the accelerator is a Math accelerator.

In some embodiments, an RDMA application (such as applications 114a, 114b) coordinates its computation and communication phases into chunks using time. In some embodiments, the computation phase performs a mathematical operation. In some embodiments, the mathematical operation is compute intensive. In some embodiments, the operation is an Artificial Intelligence operation. In some embodiments, the operation is a Machine Learning operation. In some embodiments, the operation is a Vector processing operation. In some embodiments, the operation is a video processing operation. In some embodiments, the operation is a Tensor Flow operation. In some embodiments, the operation is a compression or decompression operation. In some embodiments, the operation is an encryption or decryption operation. In some embodiments, the operation is a Quantum Computing operation.

In some embodiments, the communication phase performs transfers. In some embodiments, the transfers contain data. In some embodiments, the data is part of an RDMA read. In some embodiments, the data is part of an RDMA write. In some embodiments, the data is part of an RDMA send. In some embodiments, the transfers contain control information. In some embodiments, the control information includes setting up a transfer. In some embodiments, the control information includes tearing down a transfer. In some embodiments, the control information is an ACK message. In some embodiments, the control information is a send queue entry.

In some embodiments, the phases are dictated by precise time, e.g., based on the TPT 116a, 116b. In some embodiments, the phases are seen at a processor. In some embodiments, the phases are seen at a memory. In some embodiments, the memory is a cache memory. In some embodiments, the memory is a first-in first-out (FIFO) memory. In some embodiments, the memory is a structure inside a cache memory. In some embodiments, the memory is host memory. In some embodiments, the memory is on a different chiplet. In some embodiments, the memory is connected by CXL. In some embodiments, the phases are seen at a memory controller. In some embodiments, the memory controller is a cache controller. In some embodiments, the phases are seen at the server. In some embodiments, the phases are seen at the client. In some embodiments, the phases are seen at a NIC. In some embodiments, the phases are seen at an IPU. In some embodiments, the phases are seen at a GPU. In some embodiments, the phases are seen at an accelerator. In some embodiments, the phases are seen at a common point. In some embodiments, the phases are seen at a network appliance. In some embodiments, the network is an Ethernet network. In some embodiments, the network is an Ultra Ethernet network. In some embodiments, the network is PCI or PCIe. In some embodiments, the network is CXL. In some embodiments, the appliance used for storage of data.

In some embodiments, the precise time in the TPTs 116a, 116b include adjustments for latency. In some embodiments, the latency is a one-way latency from a client to a server. In some embodiments, the latency is a one-way latency from a server to a client. In some embodiments, the latency is a one-way latency between a point associated with the client and a point associated with the server. In some embodiments, the point is one or more of a NIC, IPU, Cache Management Unit, Memory Management Unit, CPU, GPU, vision processing unit (VPU), video transcoding unit (VCU), tensor processing unit (TPU), Switch, network appliance, CXL device, Memory, Cache, Portion of the Cache (e.g., NIC accessible portion 608), or a Chiplet.

In some embodiments, the latency is a one-way latency between a point associated with the server and a point associated with the client. In some embodiments, the point is one or more of a NIC, IPU, Cache Management Unit, Memory Management Unit, CPU, GPU, VPU, VCU, TPU, Switch, network appliance, CXL device, Memory, Cache, Portion of the Cache (NIC accessible portion 608), or a Chiplet.

In some embodiments, the data chunk improves latency. In some embodiments, the data chunk improves performance. In some embodiments, the data chunk improves area. In some embodiments, the data chuck is all or a portion of the memory. In some embodiments, the portion of the memory is defined by network interface controller. In some embodiments, the portion of the memory is defined by an algorithm to increase performance of an application. In some embodiments, the application is RDMA. In some embodiments, the portion of the memory is part of a buffering scheme. In some embodiments, the buffering scheme is a ping pong scheme. In some embodiments, one set of memory is used while the another set of memory is loading data. In some embodiments, the buffering scheme has more than two memory areas. In some embodiments, at least one area is used for computation. In some embodiments, at least one area is being loaded with new data. In some embodiments, at least one area is being invalidated, evicted, flushed, etc. In some embodiments, at least one area is being fenced.

In some embodiments, the time is a precise time. In some embodiments, the precise time is communicated by IEEE1588. In some embodiments, the precise time is communicated using PTM. In some embodiments, the precise time is communicated using PPS. In some embodiments, the precise time is communicated by a clock. In some embodiments, the precise time is communicated using a proprietary method. In some embodiments, the precise time is validated by one or more of IEEE1588, PTM, PPS or a proprietary method. In some embodiments, the precise time is within a guaranteed limit for the devices. In some embodiments, the devices are a warehouse computer. In some embodiments, the devices are in a single data center. In some embodiments, the devices are in multiple data centers. In some embodiments, the devices are scattered. In some embodiments, the devices are scattered across geographies.

In some embodiments, the time is an accurate time. In some embodiments, the time is both precise and accurate. In some embodiments, the RDMA application communicates precise time between RDMA nodes. In some embodiments, a node is a server. In some embodiments, a node is a client. In some embodiments, a node is a NIC or IPU. In some embodiments, a node is a CPU. In some embodiments, a node is a GPU. In some embodiments, the RDMA application receives precise time from a precise time source. In some embodiments, the precise time source is IEEE1588, PTM, PPS, ap proprietary method, any a combination of thereof.

In some embodiments, the RDMA application coordinates with the transport layer. In some embodiments, the transport layer paces traffic. In some embodiments, the transport layer communicates time. In some embodiments, the transport layer is instructed by the RDMA application. In some embodiments, the transport layer is time aware. In some embodiments, the transport layer is implemented in a device such as computing system 102a or computing system 102b. In some embodiments, the device is a server. In some embodiments, the device is a client system. In some embodiments, the device is a NIC or IPU. In some embodiments, the device is a CPU. In some embodiments, the device is a GPU. In some embodiments, the device is a switch. In some embodiments, the device is an accelerator.

In some embodiments, the RDMA application uses precise time instead of interrupts. In some embodiments, the RDMA application uses precise time to avoid large context swaps. In some embodiments, the RDMA application uses precise time to avoid thrashing. In some embodiments, the thrashing is cache thrashing. In some embodiments, the transfers are paced. In some embodiments, the pacing for communication is different than the computation pacing. In some embodiments, the communications are paced. In some embodiments, the data for computation is paced.

In some embodiments, an RDMA Memory Operations (MEMOPS) are associated with a time, e.g., in the TPTs 116a, TPT 116b. In some embodiments, the time is a precise time. In some embodiments, the time is an accurate time. In some embodiments, the time is both precise and accurate. In some embodiments, the MEMOPS is a Fast Memory Registration. In some embodiments, the MEMOPS is a bind memory window operation. In some embodiments, the bind operation is a Type A bind operation. In some embodiments, the bind operation is a Type B bind operation. In some embodiments, the MEMOPS is a Local Invalidate. In some embodiments, the local invalidate frees up memory for the next application. In some embodiments, the memory is part of a cache. In some embodiments, the cache is an L1 Cache. In some embodiments, the cache is an L2 Cache. In some embodiments, the cache is a Last Level Cache. In some embodiments, the cache is designed for a data transfer. In some embodiments, the memory is FIFO. In some embodiments, the transfer involves hints. In some embodiments, the transfer involves Steering tags. In some embodiments, the transfer occurs over PCIe. In some embodiments, the transfer occurs over CXL. In some embodiments, the local invalidate frees up memory for data. In some embodiments, the memory is part of a Cache. In some embodiments, the cache is an L1 Cache. In some embodiments, the cache is an L2 Cache. In some embodiments, the cache is a Last Level Cache. In some embodiments, the cache is designed for a data transfer. In some embodiments, the memory is FIFO. In some embodiments, the transfer involves hints. In some embodiments, the transfer involves Steering tags. In some embodiments, the transfer occurs over PCIe. In some embodiments, the transfer occurs over CXL. In some embodiments, the memory is part of a buffering scheme. In some embodiments, the buffer scheme is a ping pong scheme. In some embodiments, the buffer scheme has more than two buffers. In some embodiments, the buffer scheme allows for low latency. In some embodiments, the local invalidate reduces power. In some embodiments, the local invalidate reduces latency. In some embodiments, the local invalidate improves performance.

In some embodiments, an RDMA operation uses a time as part of the operation. In some embodiments, the RDMA operation is a read operation. In some embodiments, the RDMA operation is a write operation. In some embodiments, the RDMA operation is a send operation. In some embodiments, the RDMA operation is an atomic operation. In some embodiments, the operation sets a lock. In some embodiments, the lock occurs at a precise time as specified by the TPT 116a or TPT 116b. In some embodiments, the lock occurs at a precise time window as specified by the TPT 116a or TPT 116b. In some embodiments, the RDMA operation removes a lock. In some embodiments, the removal of the lock occurs at a precise time as specified by the TPT 116a or TPT 116b. In some embodiments, the removal occurs at a precise time window as specified by the TPT 116a or TPT 116b. In some embodiments, the RDMA operation is a flush operation. In some embodiments, the flush time is given as part of another operation. In some embodiments, the another operation is a write. In some embodiments, the another operation is a read. In some embodiments, the another operation is a send. In some embodiments, the another operation is an atomic operation. In some embodiments, the time is a precise time. In some embodiments, the time is an accurate time. In some embodiments, the time indicates a time of operation. In some embodiments, the time of operation is a start time. In some embodiments, the time of operation is an end time. In some embodiments, the time of operation is a window of time. In some embodiments, the time of operation is associated with a rate. In some embodiments, the time of operation is considered at the client. In some embodiments, the time of operation is considered by the client. In some embodiments, the time is considered by the server. In some embodiments, the time of operation is considered at the server or at the client. In some embodiments, a latency is estimated. The latency may be a best case latency. The latency may be a worst case latency.

In some embodiments, a latency is a one-way latency. In some embodiments, the latency is from the server to the client. In some embodiments, the latency is from the client to the server. In some embodiments, the latency considers more than one-way latency. In some embodiments, a calculation is made using the latency to determine a time to perform an RDMA operation. In some embodiments, the time is a start time. In some embodiments, the start time is at the sender. In some embodiments, the start time is at the receiver. In some embodiments, the start time is at a device. In some embodiments, the device is a server. In some embodiments, the device is a client. In some embodiments, the device is a CPU. In some embodiments, the device is a GPU. In some embodiments, the device is an accelerator. In some embodiments, the device is an AI accelerator. In some embodiments, the device is an appliance. In some embodiments, the device is a storage appliance. In some embodiments, the time is an end time or completion time or final transfer time. In some embodiments, the time is used with a data size (e.g., a transfer rate). In some embodiments, there is a rate (e.g., a data rate). In some embodiments, the rate is in bytes per nanosecond. In some embodiments, the rate is in KBs per microsecond. In some embodiments, the rate is in MBs per microsecond. In some embodiments, the rate is used for pacing. In some embodiments, the operation includes an update to the Completion Queue. In some embodiments, the operation includes an update to the send queue. In some embodiments, the operation includes an update to a receive queue. In some embodiments, the operation is in an area defined by the network interface controller. In some embodiments, the operation is managed by a QoS algorithm. In some embodiments, the RDMA operation uses precise time instead of interrupts. In some embodiments, the RDMA operation uses precise time to avoid large context swaps. In some embodiments, the RDMA operation uses precise time to avoid thrashing. In some embodiments, the thrashing is cache thrashing.

In some embodiments, a fencing operation uses time. In some embodiments, the Fencing operation is part of an RDMA operation. In some embodiments, the time is a precise time. In some embodiments, the time is an accurate time. In some embodiments, the time indicates a time of operation. In some embodiments, the time of operation is a start time. In some embodiments, the time of operation is an end time. In some embodiments, the time of operation is an invalidate time. In some embodiments, the fencing operation occurs in association with a second command. In some embodiments, the second command is an invalidate command. In some embodiments, the second command is an erase command. In some embodiments, the second command is an evict command. In some embodiments, the second command is used to store new data. In some embodiments, the second command is a read. In some embodiments, the second command is a write. In some embodiments, the second command is a send. In some embodiments, the second command is atomic. In some embodiments, the fencing operation occur after a previous command. In some embodiments, the second command is a read. In some embodiments, the second command is a write. In some embodiments, the second command is a send. In some embodiments, the second command is atomic. In some embodiments, the fence operation occurs in a device between the server and the client, including the server and the client. In some embodiments, the device is an IPU. In some embodiments, the device is a NIC. In some embodiments, the device is a CPU. In some embodiments, the device is a GPU. In some embodiments, the device communicates with PCIe. In some embodiments, the device communicates with CXL. In some embodiments, the device communicates with Universal Chiplet Interconnect Express (UCIe). In some embodiments, the device is a memory device. In some embodiments, the device is a chiplet. In some embodiments, the device is an Ethernet device. In some embodiments, the device is an Ultra Ethernet device. In some embodiments, the device is the client. In some embodiments, the device is the server. In some embodiments, the device contains a memory for storage. In some embodiments, the storage is a cache. In some embodiments, the storage is a FIFO. In some embodiments, the storage has multiple level. In some embodiments, the fencing operation uses precise time instead of interrupts. In some embodiments, the fencing operation uses precise time to avoid large context swaps. In some embodiments, the fencing uses precise time to avoid thrashing. In some embodiments, the thrashing is cache thrashing.

In some embodiments, an RDMA transfer uses one-way transfer time. In some embodiments, the time is from a first device to a second device. In some embodiments, the first device is a server. In some embodiments, the first device is a client. In some embodiments, the second device is a server. In some embodiments, the second device is a client. In some embodiments, at least one of the devices is a virtual machine. In some embodiments, at least one of the devices is a CPU. In some embodiments, at least one of the devices is a GPU. In some embodiments, at least one of the devices is on a chiplet. In some embodiments, at least one of the devices is an accelerator. In some embodiments, at least one of the devices is a memory device. In some embodiments, the memory device is a cache. In some embodiments, the transfer time is based on probes. In some embodiments, the direction of the probes is in the direction of the data transfer. In some embodiments, the time is from a client to a server. In some embodiments, the time is from client NIC/IPU to server or server's NIC/IPU. In some embodiments, the time is from server NIC/IPU to client or client's NIC/IPU. In some embodiments, the time is from client memory/cache to server or server's NIC/IPU/memory/cache. In some embodiments, the time is from server memory/cache to client or client's NIC/IPU/memory/cache. In some embodiments, the one-way transfer time is included in an RDMA message. In some embodiments, the message is an acknowledge. In some embodiments, the time includes the latency crossing PCIe. In some embodiments, the time includes the latency crossing CXL. In some embodiments, the time includes the latency crossing a proprietary connection. In some embodiments, the time includes the latency crossing UCIe. In some embodiments, the time includes the latency between one or more chiplets. In some embodiments, the one-way transfer time is used to adjust RDMA transfers. In some embodiments, the one-way transfer time is used to adjust one or more RDMA data rates. In some embodiments, the one-way transfer time is consumed by the RDMA application. Doing so may improve performance, improve latency, and/or reduce power. In some embodiments, doing so may indicate a transfer start time. In some embodiments, doing so may indicate a transfer end time. In some embodiments, doing so may indicate a “must be received by a specified time.” In some embodiments, doing so indicates a transfer window.

In some embodiments, a device implements a data transfer protocol to place data into a just-in-time memory before a precise time. In some embodiments, the protocol is RDMA. In some embodiments, the data is from an RDMA write. In some embodiments, the data is from an RDMA read. In some embodiments, the data is from an RDMA send. In some embodiments, the data is from an RDMA atomic. In some embodiments, the device is a NIC. In some embodiments, the device is a IPU. In some embodiments, the device is a CPU. In some embodiments, the device is a GPU. In some embodiments, the device is an FPGA. In some embodiments, the device is an accelerator. In some embodiments, the accelerator performs an Artificial Intelligence operation. In some embodiments, the accelerator performs a Machine Learning operation. In some embodiments, the accelerator processes vectors. In some embodiments, the accelerator processes video. In some embodiments, the device is a memory. In some embodiments, the memory is a cache associated with a CPU, GPU, IPU, and/or a NIC. In some embodiments, the just-in-time memory is part of a cache. The cache may be an L1 cache. The cache may be an L2 cache. The cache may be an Last Level Cache. The cache may be a specialized cache. The cache may be a cache for an AI accelerator. The cache may be for a networking accelerator. In some embodiments, the part of the cache is reserved. In some embodiments, the cache reservation mechanism is via an NIC. In some embodiments, the just-in-time memory is FIFO. In some embodiments, the just-in-time memory is a scratch pad. In some embodiments, the placed data is data. In some embodiments, the placed data is information. In some embodiments, the information is related to a queue. In some embodiments, the information is related to a queue pair. In some embodiments, the information is related to a send queue. In some embodiments, the information is related to a completion queue. In some embodiments, the information is related to a receive queue. In some embodiments, the NIC/IPU/DPU holds RDMA data until a time specified in a TPT 116a or TPT 116b and then transfers to a device. In some embodiments, the hold is coalescing multiple incoming data segments. In some embodiments, the device is CPU. In some embodiments, the device is a memory. In some embodiments, the device is a cache. In some embodiments, the transfer that is delayed. In some embodiments, the time is accurate. In some embodiments, the time is precise.

In some embodiments, a processing device stores RDMA control information in a low latency memory. In some embodiments, the low latency memory is a cache. In some embodiments, the cache is a L1 cache. In some embodiments, the cache is a L2 Cache. In some embodiments, the cache is a Last Level Cache. In some embodiments, the cache is a specialized cache. In some embodiments, the low latency memory implements a reservation algorithm. In some embodiments, the RDMA control information is one or more of: queue entries, send queues, completion queues, pointers, head pointers, tail pointers, buffer lists, physical memory locations, parameters, and/or variables. In some embodiments, the storing saves power. In some embodiments, the storing reduces latency. In some embodiments, the storing reduces cache thrashing. In some embodiments, the storing increases bandwidth. In some embodiments, the bandwidth is Ethernet Bandwidth. In some embodiments, the bandwidth is Ultra Ethernet bandwidth. In some embodiments, the bandwidth is PCIe Bandwidth. In some embodiments, the bandwidth is CXL Bandwidth. In some embodiments, the bandwidth is Memory Bandwidth. In some embodiments, the bandwidth is chiplet interface bandwidth.

in some embodiments, time aware RDMA interacts with a time aware transport protocol. In some embodiments, the protocol is the transmission control protocol (TCP). In some embodiments, TCP is time aware. In some embodiments, the protocol is the User Datagram Protocol (UDP). In some embodiments, UDP is time aware. In some embodiments, the protocol is a reliable transport, RT, protocol. In some embodiments, RT is time aware. In some embodiments, the protocol is a proprietary protocol. In some embodiments, the protocol is NVLink. In some embodiments, the NVLink protocol is time aware. In some embodiments, the protocol is Ethernet. In some embodiments, the protocol is Ultra Ethernet. In some embodiments, the Ethernet or Ultra Ethernet is time aware. In some embodiments, the transport protocol consumes a precise time. In some embodiments, the transport protocol consumes an accurate time. In some embodiments, the transport protocol indicates a start time. In some embodiments, the transport protocol indicates an end time. In some embodiments, the transport protocol dictates a data rate. In some embodiments, the transport protocol dictates precise times to perform transfers. In some embodiments, the transport protocol limits when RDMA can transfer data. In some embodiments, the transport protocol updates windows for transfers. In some embodiments, the RDMA can preempt packet based on precise time. In some embodiments, data of a high QOS can be injected into a stream of a lower QoS data in a transfer. In some embodiments, the pre-emption happens in a scheduler. In some embodiments, packets are pre-empted.

In some embodiments, an RDMA device or an application uses precise time to handle faults. In some embodiments, a fault is an error. In some embodiments, a fault is reported. In some embodiments, a fault causes an interrupt. In some embodiments, a fault causes packet drop. In some embodiments, one or more faults accumulate until a precise time. In some embodiments, multiple faults are reported at a precise time. In some embodiments, all faults are reported at a precise time or at a precise rate. In some embodiments, faults are handled during precise time windows. In some embodiments, a fault is considered a fault after a precise time. In some embodiments, a fault occurs at a precise time or precise time window. In some embodiments, faults are ignored during a precise time window. In some embodiments, error handling of faults occur at precise times or during precise time windows.

In some embodiments, an RDMA device or application uses time to reduce Multi-flow jitter. In some embodiments, the multi-flow contains flows of different classes. In some embodiments, the multi-flow contains different destination devices. In some embodiments, the destination device is a host in a multi-host system. In some embodiments, the destination device is one or more of a CPU, GPU, NIC, IPU, DPU, TPU, Accelerator, VCU, CPU, appliance, memory device, cache, and/or portion of the cache. In some embodiments, the time is a precise time. In some embodiments, the precise time is communicated by IEEE1588. In some embodiments, the precise time is communicated using PTM. In some embodiments, the precise time is communicated using PPS. In some embodiments, the precise time is communicated using a proprietary method. In some embodiments, the precise time is validated by IEEE1588, PTM, PPS or a proprietary method. In some embodiments, the precise time is within a guaranteed limit for the devices. In some embodiments, the devices are a warehouse computer. In some embodiments, the devices are in a single data center. In some embodiments, the devices are in multiple data centers. In some embodiments, the devices are scattered. In some embodiments, they are scattered across geographies. In some embodiments, the time is an accurate time. In some embodiments, the time is both precise and accurate.

In some embodiments, a first device uses time to control a second device's incast. In some embodiments, the first device runs an RDMA application. In some embodiments, the device is a NIC, IPU, or a GPU. In some embodiments, the control method is pacing. In some embodiments, the control method uses time slots or a TDM-type operation. In some embodiments, the second device is a networking device. In some embodiments, it is a switch. In some embodiments, it is a router. In some embodiments, it is a network appliance. In some embodiments, it is an IPU. In some embodiments, it is a NIC. In some embodiments, the time is a precise time. In some embodiments, the precise time is communicated by IEEE1588. In some embodiments, the precise time is communicated using PTM. In some embodiments, the precise time is communicated using PPS. In some embodiments, the precise time is communicated using a proprietary method. In some embodiments, the precise time is validated by IEEE1588, PTM, PPS or a proprietary method. In some embodiments, the precise time is within a guaranteed limit for the devices. In some embodiments, the devices are a warehouse computer. In some embodiments, the devices are in a single data center. In some embodiments, the devices are in multiple data centers. In some embodiments, the devices are scattered. In some embodiments, they are scattered across geographies. In some embodiments, the time is an accurate time. In some embodiments, the time is both precise and accurate. In some embodiments, one of the devices runs Map Reduce. In some embodiments, one of the devices run Hadoop. In some embodiments, one of the devices is a collection device. In some embodiments, the collection device orders the results of multiple devices.

In some embodiments, one or more computing elements may use time for dynamic rerouting streams. The dynamic rerouting may be the equal cost multi-path (ECMP) routing scheme. In some embodiments, the routing scheme uses a 5 tuple to determine which port to do the transfer the data. In some embodiments, the same flow goes out the same switch port. In some embodiments, the dynamic rerouting statically sprays the packets (load balance). In some embodiments, AI and high performance computing (HPC) have a small number of endpoints. In some embodiments, the endpoint is one peer. In some embodiments, gigabits per second are provided to the peer.

Some ECMP collisions may occur. In some embodiments, some uplinks are pathologically congested while others are empty. In some embodiments, network underutilization especially with small connection counts. In some embodiments, dynamic routing could help make choices, switch over to a different egress port for higher utilization. Doing so may cause packets to become out of order and/or cause path delays to be different. In some embodiments, routing schemes include the dynamic routing algorithms. In some embodiments, time is a precise time. In some embodiments, time is an accurate time. In some embodiments, the rerouting of streams occurs at precise times or during precise time window. In some embodiments, the rerouting of streams uses one way latency measurements. In some embodiments, the lowest expected one-way latency is selected for routing.

In some embodiments, PCC (Programmable Congestion Control) may be implemented. In some embodiments, the PCC may use time control windows to schedule traffic. In some embodiments, PCC may measure the times it takes for packets to transverse the network, and then adjust the traffic accordingly. The PCC may use round trip time (in the absence of precise time) to make the decisions. As a data transmitter adds its own time stamp and own time base to the receive endpoint returns it to the send in the ACK or other packets. Using the round trip time over time for many packets, the control algorithm reacts accordingly.

In some embodiments, Unidirectional Time Measurement is used with PCC. If PTP is used with both endpoints that are synchronized (e.g., to 100 ns), a unidirectional delay could be measured, and see only the congestion in the path to the data sender in the ACK response (regardless of congestion/jitter in the ACK direction). 100 ns is in the noise for network jitter. Dedicated, high priority may be given to the ACK messages.

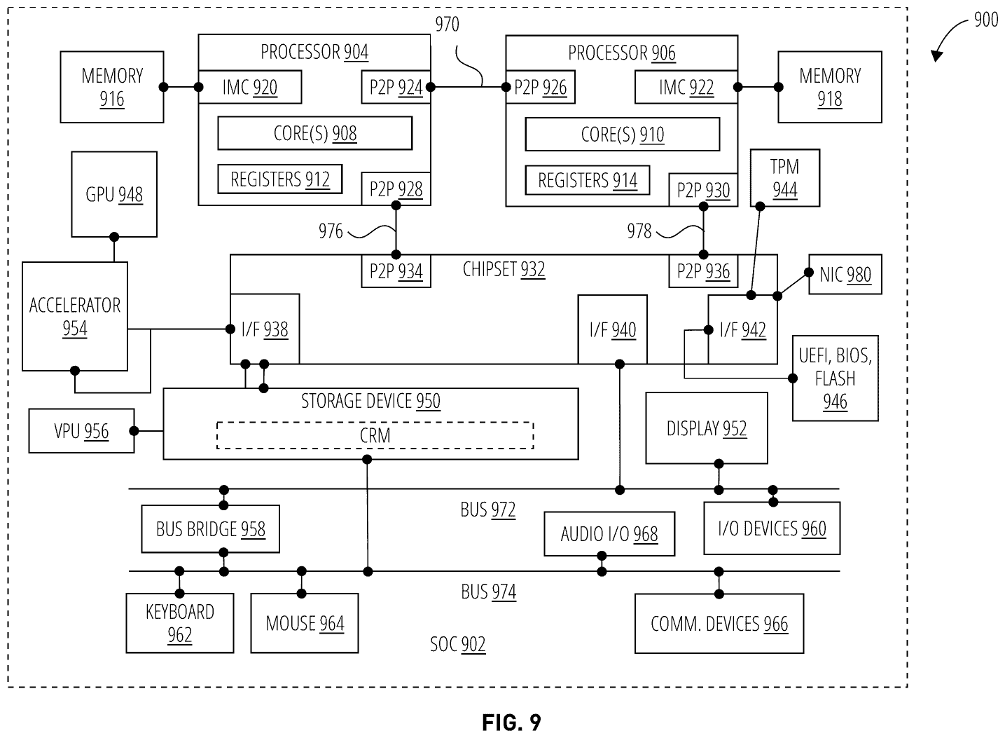

FIG. 9 illustrates an embodiment of a system 900. System 900 is a computer system with multiple processor cores such as a distributed computing system, supercomputer, high-performance computing system, computing cluster, mainframe computer, an Infrastructure Processing Unit (IPU), a data processing unit (DPU), mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. Examples of IPUs include the AMD® Pensando IPU. Examples of DPUs include the Fungible DPU, the Marvell® OCTEON and ARMADA DPUs, the NVIDIA BlueField® DPU, the ARM® Neoverse N2 DPU, and the AMD® Pensando DPU. In other embodiments, the system 900 may have a single processor with one core or more than one processor. Note that the term “processor” refers to a processor with a single core or a processor package with multiple processor cores. In at least one embodiment, the computing system 900 is representative of the components of the system 100. More generally, the computing system 900 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 9, system 900 comprises a system-on-chip (SoC) 902 for mounting platform components. System-on-chip (SoC) 902 is a point-to-point (P2P) interconnect platform that includes a first processor 904 and a second processor 906 coupled via a point-to-point interconnect 970 such as an Ultra Path Interconnect (UPI). In other embodiments, the system 900 may be of another bus architecture, such as a multi-drop bus. Furthermore, each of processor 904 and processor 906 may be processor packages with multiple processor cores including core(s) 908 and core(s) 910, respectively. While the system 900 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 904 and chipset 932. Some platforms may include additional components and some platforms may include sockets to mount the processors and/or the chipset. Furthermore, some platforms may not have sockets (e.g. SoC, or the like). Although depicted as a SoC 902, one or more of the components of the SoC 902 may also be included in a single die package, a multi-chip module (MCM), a multi-die package, a chiplet, a bridge, and/or an interposer. Therefore, embodiments are not limited to a SoC. The SOC 902 is an example of the computing system 102a and the computing system 102b.

The processor 904 and processor 906 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 904 and/or processor 906. Additionally, the processor 904 need not be identical to processor 906.

Processor 904 includes an integrated memory controller (IMC) 920 and point-to-point (P2P) interface 924 and P2P interface 928. Similarly, the processor 906 includes an IMC 922 as well as P2P interface 926 and P2P interface 930. IMC 920 and IMC 922 couple the processor 904 and processor 906, respectively, to respective memories (e.g., memory 916 and memory 918). Memory 916 and memory 918 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 916 and the memory 918 locally attach to the respective processors (e.g., processor 904 and processor 906). In other embodiments, the main memory may couple with the processors via a bus and shared memory hub. Processor 904 includes registers 912 and processor 906 includes registers 914.

System 900 includes chipset 932 coupled to processor 904 and processor 906. Furthermore, chipset 932 can be coupled to storage device 950, for example, via an interface (I/F) 938. The I/F 938 may be, for example, a Peripheral Component Interconnect Express (PCIe) interface, a Compute Express Link® (CXL) interface, or a Universal Chiplet Interconnect Express (UCIe) interface. Storage device 950 can store instructions executable by circuitry of system 900 (e.g., processor 904, processor 906, GPU 948, accelerator 954, vision processing unit 956, or the like).

Processor 904 couples to the chipset 932 via P2P interface 928 and P2P 934 while processor 906 couples to the chipset 932 via P2P interface 930 and P2P 936. Direct media interface (DMI) 976 and DMI 978 may couple the P2P interface 928 and the P2P 934 and the P2P interface 930 and P2P 936, respectively. DMI 976 and DMI 978 may be a high-speed interconnect that facilitates, e.g., eight Giga Transfers per second (GT/s) such as DMI 3.0. In other embodiments, the processor 904 and processor 906 may interconnect via a bus.

The chipset 932 may comprise a controller hub such as a platform controller hub (PCH). The chipset 932 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 932 may comprise more than one controller hub such as a chipset with a memory controller hub, a graphics controller hub, and an input/output (I/O) controller hub.

In the depicted example, chipset 932 couples with a trusted platform module (TPM) 944 and UEFI, BIOS, FLASH circuitry 946 via I/F 942. The TPM 944 is a dedicated microcontroller designed to secure hardware by integrating cryptographic keys into devices. The UEFI, BIOS, FLASH circuitry 946 may provide pre-boot code.

Furthermore, chipset 932 includes the I/F 938 to couple chipset 932 with a high-performance graphics engine, such as, graphics processing circuitry or a graphics processing unit (GPU) 948. In other embodiments, the system 900 may include a flexible display interface (FDI) (not shown) between the processor 904 and/or the processor 906 and the chipset 932. The FDI interconnects a graphics processor core in one or more of processor 904 and/or processor 906 with the chipset 932.

The system 900 is operable to communicate with wired and wireless devices or entities via the network interface controller (NIC) 980 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 954 and/or vision processing unit 956 can be coupled to chipset 932 via I/F 938. The accelerator 954 is representative of any type of accelerator device (e.g., a data streaming accelerator, cryptographic accelerator, cryptographic co-processor, an offload engine, etc.). Examples of an accelerator 954 include the AMD Instinct® or Radeon® accelerators, the NVIDIA® HGX and SCX accelerators, and the ARM Ethos-U NPU.

The accelerator 954 may be a device including circuitry to accelerate copy operations, data encryption, hash value computation, data comparison operations (including comparison of data in memory 916 and/or memory 918), and/or data compression. For example, the accelerator 954 may be a USB device, PCI device, PCIe device, CXL device, UCIe device, and/or an SPI device. The accelerator 954 can also include circuitry arranged to execute machine learning (ML) related operations (e.g., training, inference, etc.) for ML models. Generally, the accelerator 954 may be specially designed to perform computationally intensive operations, such as hash value computations, comparison operations, cryptographic operations, and/or compression operations, in a manner that is more efficient than when performed by the processor 904 or processor 906. Because the load of the system 900 may include hash value computations, comparison operations, cryptographic operations, and/or compression operations, the accelerator 954 can greatly increase performance of the system 900 for these operations.

The accelerator 954 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator capable of performing the functions described herein. In some embodiments, the accelerator 954 may be packaged in a discrete package, an add-in card, a chipset, a multi-chip module (e.g., a chiplet, a dielet, etc.), and/or an SoC. Embodiments are not limited in these contexts.

The accelerator 954 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 954. For example, the accelerator 954 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 954 via a non-posted write (e.g., a deferred memory write (DMWr)). One example of an instruction that atomically submits a work descriptor to the shared work queue of the accelerator 954 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 954. The dedicated work queue may accept job submissions via commands such as the movdir64b instruction.

Various I/O devices 960 and display 952 couple to the bus 972, along with a bus bridge 958 which couples the bus 972 to a second bus 974 and an I/F 940 that connects the bus 972 with the chipset 932. In one embodiment, the second bus 974 may be a low pin count (LPC) bus. Various devices may couple to the second bus 974 including, for example, a keyboard 962, a mouse 964 and communication devices 966.

Furthermore, an audio I/O 968 may couple to second bus 974. Many of the I/O devices 960 and communication devices 966 may reside on the system-on-chip (SoC) 902 while the keyboard 962 and the mouse 964 may be add-on peripherals. In other embodiments, some or all the I/O devices 960 and communication devices 966 are add-on peripherals and do not reside on the system-on-chip (SoC) 902.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to the Figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.
Example 1 includes an apparatus, comprising: an interface to a processor; and circuitry, the circuitry to: associate, in a translation protection table (TPT), a time with a remote direct memory access (RDMA) operation; and permit or restrict the RDMA operation based on the time in the TPT.
Example 2 includes the subject matter of example 1, the circuitry to: associate, in the TPT, a time with an RDMA key associated with the RDMA operation; and permit or restrict use of the RDMA key based on the time associated with the RDMA key.
Example 3 includes the subject matter of example 1, the RDMA operation associated with an application to be executed on the processor, the time to be associated with a queue pair associated with the application.
Example 4 includes the subject matter of example 1, wherein the apparatus is to comprise one or more of a network interface controller (NIC), an infrastructure processing unit (IPU), a field programmable gate array (FPGA), an accelerator device, a networking apparatus, or a data processing unit (DPU).
Example 5 includes the subject matter of example 1, the RDMA operation to comprise an RDMA read operation of data from a remote apparatus, the circuitry to: write the data to a cache of the processor based on the time.
Example 6 includes the subject matter of example 1, the time to be based on Institute of Electrical and Electronic Engineers (IEEE) 1588 time source.
Example 7 includes the subject matter of example 1, the circuitry to: permit or restrict access to the TPT based on a number of credits allocated to an application associated with the RDMA operation.
Example 8 includes a method, comprising: associating, by circuitry and in a translation protection table (TPT), a time with a remote direct memory access (RDMA) operation; and permitting or restricting, by the circuitry, the RDMA operation based on the time in the TPT.
Example 9 includes the subject matter of example 8, further comprising: associating, by the circuitry and in the TPT, a time with an RDMA key associated with the RDMA operation; and permitting or restricting, by the circuitry, use of the RDMA key based on the time associated with the RDMA key.
Example 10 includes the subject matter of example 8, the RDMA operation associated with an application to be executed on a processor coupled to the circuitry, the time to be associated with a queue pair associated with the application.
Example 11 includes the subject matter of example 8, wherein the circuitry is to be included in one or more of a network interface controller (NIC), an infrastructure processing unit (IPU), a field programmable gate array (FPGA), an accelerator device, a networking apparatus, or a data processing unit (DPU).
Example 12 includes the subject matter of example 8, the RDMA operation to comprise an RDMA read operation of data from a remote apparatus, the method further comprising: writing, by the circuitry, the data to a cache of a processor based on the time.
Example 13 includes the subject matter of example 8, the time to be based on Institute of Electrical and Electronic Engineers (IEEE) 1588 time source.
Example 14 includes the subject matter of example 8, further comprising: permitting or restricting, by the circuitry, access to the TPT based on a number of credits allocated to an application associated with the RDMA operation.
Example 15 includes a non-transitory computer-readable storage medium, the computer-readable storage medium including instructions that when executed by a processor, cause the processor to: associate, in a translation protection table (TPT), a time with a remote direct memory access (RDMA) operation; and permit or restrict the RDMA operation based on the time in the TPT.
Example 16 includes the subject matter of example 15, wherein the instructions further cause the processor to: associate, in the TPT, a time with an RDMA key associated with the RDMA operation; and permit or restrict use of the RDMA key based on the time associated with the RDMA key.
Example 17 includes the subject matter of example 15, the RDMA operation associated with an application, the time to be associated with a queue pair associated with the application.
Example 18 includes the subject matter of example 15, wherein the processor is to be included in one or more of a network interface controller (NIC), an infrastructure processing unit (IPU), a field programmable gate array (FPGA), an accelerator device, a networking apparatus, or a data processing unit (DPU).
Example 19 includes the subject matter of example 15, the RDMA operation to comprise an RDMA read operation of data from a remote apparatus, wherein the instructions further cause the processor to: write the data to a cache of the processor based on the time.
Example 20 includes the subject matter of example 15, the time to be based on Institute of Electrical and Electronic Engineers (IEEE) 1588 time source.
Example 21 includes the subject matter of example 15, wherein the instructions further cause the processor to: permit or restrict access to the TPT based on a number of credits allocated to an application associated with the RDMA operation.
Example 22 includes an apparatus, comprising: means for associating a time with a remote direct memory access (RDMA) operation; and means for permitting or restricting the RDMA operation based on the time.
Example 23 includes the subject matter of example 22, further comprising: means for associating a time with an RDMA key associated with the RDMA operation; and means for permitting or restricting use of the RDMA key based on the time associated with the RDMA key.
Example 24 includes the subject matter of example 22, the RDMA operation associated with an application, the time to be associated with a queue pair associated with the application.
Example 25 includes the subject matter of example 22, wherein the apparatus comprises one or more of a network interface controller (NIC), an infrastructure processing unit (IPU), a field programmable gate array (FPGA), an accelerator device, a networking apparatus, or a data processing unit (DPU).
Example 26 includes the subject matter of example 22, the RDMA operation to comprise an RDMA read operation of data from a remote apparatus, the further comprising: means for writing the data to a cache of a processor based on the time.
Example 27 includes the subject matter of example 22, the time to be based on Institute of Electrical and Electronic Engineers (IEEE) 1588 time source.
Example 28 includes the subject matter of example 22, further comprising: means for permitting or restricting access the time associated with the RDMA operation based on a number of credits allocated to an application associated with the RDMA operation.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. An apparatus, comprising:
an interface to a processor; and
circuitry, the circuitry to:
associate, in a translation protection table (TPT), a time with a remote direct memory access (RDMA) operation; and
permit or restrict the RDMA operation based on the time in the TPT.

2. The apparatus of claim 1, the circuitry to:
associate, in the TPT, a time with an RDMA key associated with the RDMA operation; and
permit or restrict use of the RDMA key based on the time associated with the RDMA key.

3. The apparatus of claim 1, the RDMA operation associated with an application to be executed on the processor, the time to be associated with a queue pair associated with the application.

4. The apparatus of claim 1, wherein the apparatus is to comprise one or more of a network interface controller (NIC), an infrastructure processing unit (IPU), a field programmable gate array (FPGA), an accelerator device, a networking apparatus, or a data processing unit (DPU).

5. The apparatus of claim 1, the RDMA operation to comprise an RDMA read operation of data from a remote apparatus, the circuitry to:
write the data to a cache of the processor based on the time.

6. The apparatus of claim 1, the time to be based on Institute of Electrical and Electronic Engineers (IEEE) 1588 time source.

7. The apparatus of claim 1, the circuitry to:
permit or restrict access to the TPT based on a number of credits allocated to an application associated with the RDMA operation.

8. A method, comprising:
associating, by circuitry and in a translation protection table (TPT), a time with a remote direct memory access (RDMA) operation; and
permitting or restricting, by the circuitry, the RDMA operation based on the time in the TPT.

9. The method of claim 8, further comprising:
associating, by the circuitry and in the TPT, a time with an RDMA key associated with the RDMA operation; and
permitting or restricting, by the circuitry, use of the RDMA key based on the time associated with the RDMA key.

10. The method of claim 8, the RDMA operation associated with an application to be executed on a processor coupled to the circuitry, the time to be associated with a queue pair associated with the application.

11. The method of claim 8, wherein the circuitry is to be included in one or more of a network interface controller (NIC), an infrastructure processing unit (IPU), a field programmable gate array (FPGA), an accelerator device, a networking apparatus, or a data processing unit (DPU).

12. The method of claim 8, the RDMA operation to comprise an RDMA read operation of data from a remote apparatus, the method further comprising:
writing, by the circuitry, the data to a cache of a processor based on the time.

13. The method of claim 8, the time to be based on Institute of Electrical and Electronic Engineers (IEEE) 1588 time source.

14. The method of claim 8, further comprising:
permitting or restricting, by the circuitry, access to the TPT based on a number of credits allocated to an application associated with the RDMA operation.

15. A non-transitory computer-readable storage medium, the computer-readable storage medium including instructions that when executed by a processor, cause the processor to:
associate, in a translation protection table (TPT), a time with a remote direct memory access (RDMA) operation; and
permit or restrict the RDMA operation based on the time in the TPT.

16. The computer-readable storage medium of claim 15, wherein the instructions further cause the processor to:
associate, in the TPT, a time with an RDMA key associated with the RDMA operation; and
permit or restrict use of the RDMA key based on the time associated with the RDMA key.

17. The computer-readable storage medium of claim 15, the RDMA operation associated with an application, the time to be associated with a queue pair associated with the application.

18. The computer-readable storage medium of claim 15, wherein the processor is to be included in one or more of a network interface controller (NIC), an infrastructure processing unit (IPU), a field programmable gate array (FPGA), an accelerator device, a networking apparatus, or a data processing unit (DPU).

19. The computer-readable storage medium of claim 15, the RDMA operation to comprise an RDMA read operation of data from a remote apparatus, wherein the instructions further cause the processor to:
write the data to a cache of the processor based on the time.

20. The computer-readable storage medium of claim 15, the time to be based on Institute of Electrical and Electronic Engineers (IEEE) 1588 time source.
